(19) United States
(12) Patent Application Publication
(10) Pub. No.: US 2003/0093327 A1
(43) Pub. Date: May 15, 2003

(54) Systems and methods for processing an electronic request to purchase goods or services

(75) Inventors: Linda Ann Roberts, Decatur, GA (US); Edward Michael Silver, Atlanta, GA (US); Hong Thi Nguyen, Atlanta, GA (US)

Correspondence Address: Erich M. Falke, Esq., WOODCOCK WASHBURN LLP, One Liberty Place - 46th Floor, Philadelphia, PA, 19103, US

(73) Assignee: BellSouth Intellectual Property Corporation

(21) Appl. No.: 10/008,295

(22) Filed: Nov. 13, 2001

(51) Int. Cl. G06F 17/60

(52) U.S. Cl. 705/26

(57) ABSTRACT

Systems and methods are disclosed for processing an electronic order to purchase an item via the Internet. A purchaser places an order at a client system and a server system receives the order. The server system receives with the order, an electronic request to purchase certain goods or services and notification information. The notification information is representative of at least one communication pathway for communicating with the shopper. Then the occurrence of a triggering event that affects the performance of the electronic request is recognized and the shopper is notified that the triggering event has occurred via the at least one communication pathway as represented in the notification information.

### FIELD OF THE INVENTION

The present invention relates to network services. More particularly, the present invention relates to systems and methods for processing an electronic request to purchase goods or services over a computer network.

### BACKGROUND OF THE INVENTION

The Internet is a network of computers and computer networks that are interconnected through communication pathways. The interconnected computers exchange information using various services, such as electronic mail, file transfers, and the World Wide Web (“WWW”). The WWW service operates on a client/server model. In this manner, the WWW allows a server (or host) computer system (i.e., Web server or Web site) to send Web pages of information (e.g. graphics, text, audio and video information) to a remote client computer system. The remote client computer system then displays the information in the form of Web pages. Each resource (e.g., host or Web page) of the WWW is identifiable by a unique Uniform Resource Locator (“URL”).

To view a specific Web page, a client computer system specifies the URL for that Web page in a HyperText Transfer Protocol (“HTTP”) request. The request is forwarded to the Web server that supports that Web page. After receiving the request, the server sends the Web page to the client computer system. When the client computer system receives that Web page, a browser on the client computer system displays the Web page. A browser is an application program that parses the information sent from the server and visually displays the information in the form of a Web page.

Web pages are created and displayed using HyperText Markup Language (“HTML”). An HTML document contains various tags that control the format of text, graphics, controls, and other features as they appear on a client system. When a user requests a Web page, the user's browser sends a request to the server computer system containing the Web page. The server then transfers to the client computer system an HTML document associated with the requested Web page. When the HTML document associated with the Web page is received by the client computer system, the user's browser parses the HTML document and displays the Web page according to the format defined in the HTML document.

The World Wide Web is an especially conducive marketplace for conducting electronic commerce. As such, many Web servers have been developed so electronic vendors can advertise and sell products and services over the WWW. Now, nearly all products and services available in the conventional marketplace (i.e., where face to face transactions occur) can now be bought using the Web Wide Web. For example, music can be purchased at a music vendor's website and delivered electronically over the Internet. Also, clothes can be purchased at websites and subsequently delivered through conventional delivery services. Furthermore, a server computer system (operated by an electronic vendor) may provide a browsable electronic catalog of items so the shopper can shop by clicking on items the shopper wishes to purchase. After the shopper selects the preferred items, the server computer system then prompts the shopper for information to complete the ordering of the items. This order information may include the shopper's name, credit card number, and a shipping address for the order. The server computer system may then confirm the order by sending an electronic confirmation to the shopper's computer system.

As with all types of commerce, electronic commerce can sometimes be slowed by unforeseeable delays including weather problems, inventory shortages or the like. For example, suppose a shopper buys a sofa at a furniture company showroom and expects the sofa to be delivered on a certain date determined by the furniture company. Due to an inventory shortage, however, the sofa cannot be delivered for several weeks after the delivery date. In such a situation, the furniture company will likely call the shopper and set a new delivery date. In a similar electronic commercial transaction, however, once the order is placed over the WWW and an unforeseeable event occurs, there is no predetermined way for the seller to notify the buyer of the delay. There is a need, therefore, for systems and methods for processing an electronic purchase order over a computer network such that the buyer may be notified of a delay in the performance of the request.

### BRIEF SUMMARY OF THE INVENTION

The present invention satisfies the aforementioned need by providing systems and methods for processing an electronic request to purchase goods or services over a communications network, such as the World Wide Web. In one embodiment of the present invention, a server system allows a shopper to select a notification option when buying goods or services over a communications network that notifies the shopper, by any preferred method of communication, of the occurrence of an event affecting the shopper's purchase. For example, a shopper can provide a designated email address while purchasing a book over the WWW, and if an event occurs that affects the delivery of the book, the seller will notify the shopper of such event using the provided email address.

The present invention provides systems and methods for selling goods or services over a communications network. In this regard, electronic purchasing information is received from a shopper via a communications network. The purchasing information contains an electronic request to purchase goods or services and notification information representative of at least one communication pathway for communicating with the shopper if an event occurs affecting the performance of the request. The occurrence of such an event is then recognized and the shopper is notified via the at least one communication pathway as represented in the notification information that the triggering event has occurred.

### BRIEF DESCRIPTION OF THE SEVERAL VIEWS OF THE DRAWING

Other features of the present invention are further apparent from the following detailed description of the embodiments of the present invention taken in conjunction with the accompanying drawings, of which:

FIG. 1 is a block diagram illustrating a server/client computer network as is known in the art;

FIG. 2 is a flowchart illustrating a method for processing an electronic request to purchase goods or services in accordance with the present invention;

FIG. 3 is a block diagram of a communications network having a server computer system in accordance with the present invention;

FIG. 4 is an illustration of a computer screen showing a web page incorporating a notification option in accordance with the present invention;

FIG. 5 is a block diagram of a communications network having a server system, a client system and a presence information database in communication therewith; and

FIG. 6 is a diagram illustrating a shopper profile in accordance with the present invention.

### DETAILED DESCRIPTION OF THE PRESENT INVENTION

The present invention is directed to systems and methods for processing an electronic request to purchase goods or services over a communications network such as, for example, the Internet. In one embodiment of the present invention, a server system allows a buyer to select a notification option when purchasing goods over the WWW. After selecting such an option and purchasing a good or service from an electronic vendor, the vendor can notify the buyer if an event occurs that affects the vendor's ability to deliver the good or service. For example, while purchasing an item at an electronic vendor's website, a buyer may choose a notification option on the site that causes the buyer to be notified if an event occurs that affects the delivery of the item, such as, for example, an inventory shortage. In selecting such a notification option, the buyer provides certain notification information, such as an email address, telephone number or the like, that allows the seller to contact the buyer using the notification information in case of the occurrence of such an event.

The present invention is described as being embodied in a server system on the Web Wide Web portion of the Internet. It is contemplated, however, that other communications networks may be used. For example, private or proprietary networks that are either secured or unsecured may be used without departing from the principles of the present invention.

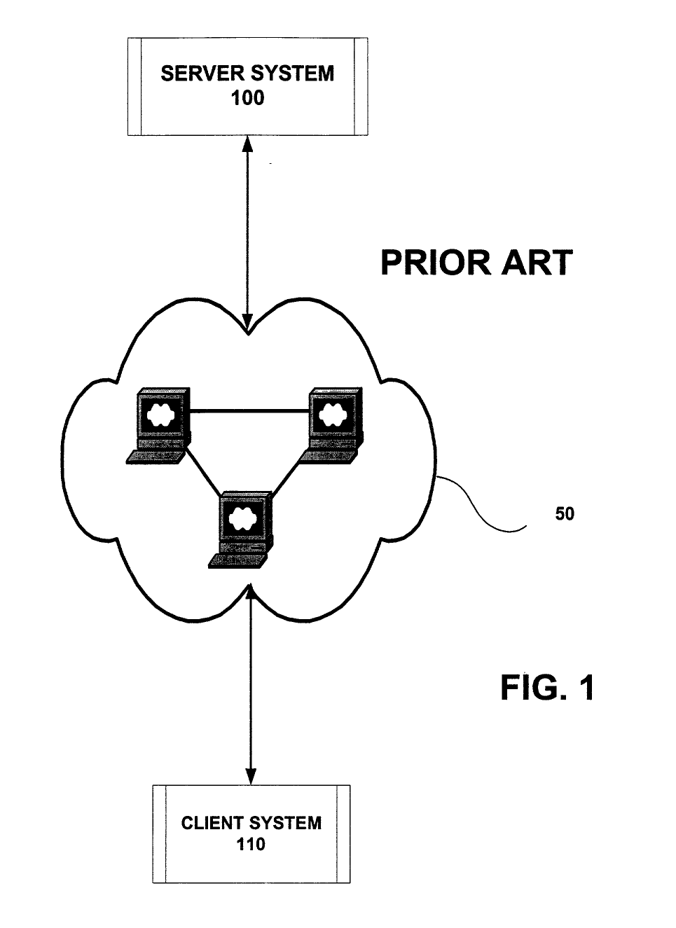

FIG. 1 is block diagram illustrating a server/client computer network model (such as that used by the WWW) as is known in the art that could be used with the present invention. As shown, client computer system 110 is in communication with network 50. The client computer system 110 can be a telephone, PDA, personal computer or any other Internet appliance, for example. Network 50 can be a Wide Area Network (WAN), such as the Internet for example or a Local Area Network (LAN), such as a proprietary intranet. Server computer system 100 is also in communication with network 50. Consequently, server computer system 100 is also in communication with client computer system 110 via network 50.

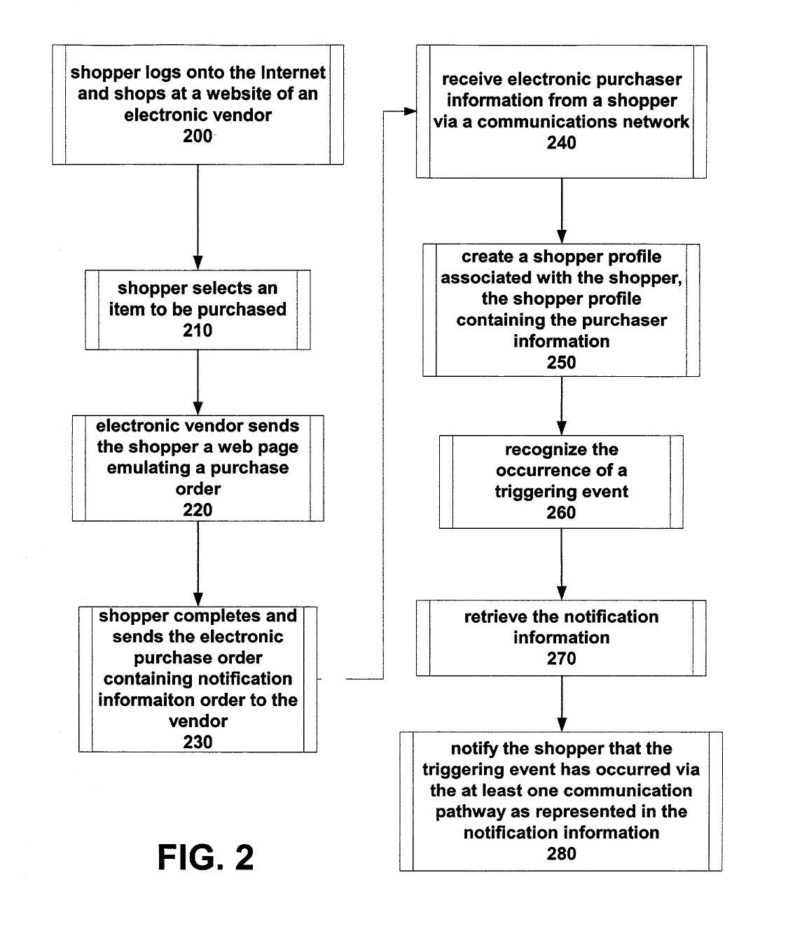

FIG. 2 is a flowchart illustrating a method of processing an electronic request from a client computer system 110 via a communications network 50 to purchase goods or services from an electronic vendor operating a server computer system 100 in accordance with the present invention. Generally, at step 200, a shopper logs onto the Internet through an Internet Service Provider and uses a web browser running on the shopper's (client) computer system 110 to view web pages associated with an electronic vendor on a server computer system 100.

After browsing various web pages illustrating different purchasable items, the shopper selects goods or services to be purchased at step 210. The vendor then sends the shopper a web page that emulates a “purchase order” at step 220. The purchaser then completes the purchase order by filling in various interactive forms embedded in the web page and sends the completed form to the vendor at step 230. Typically, the completed form includes an electronic request to purchase goods and/or services designated by an item number associated with the good or service. The electronic request also provides the vendor with other purchasing information such as, for example, the purchaser's name, delivery address, telephone number, credit card information and the like to the vendor. The structure and composition of an electronic request to purchase goods and/or services over the WWW is commonly known to those skilled in the art.

In one embodiment of the present invention, a notification option may be embedded in the web page emulating the purchase order. The notification option, when activated, allows the vendor to contact the buyer in a predetermined manner should a triggering event occur. A triggering event can be any event that affects the ability of the seller to complete the buyer's electronic request to purchase a good or service. Triggering events may include an inventory shortage, technical failures, delivery problems, personnel problems or the like. It should be appreciated that a triggering event can be any event that affects the seller's ability to perform the buyer's electronic request to purchase a good or service.

In this manner, while the buyer is providing purchasing information, the buyer can also choose to invoke the notification option by clicking on a graphic or text box associated therewith. Once the buyer submits the purchase order and has invoked the notification option, at step 240, the electronic vendor receives the electronic purchasing information from the buyer. After recognizing that the buyer has invoked the notification option, the electronic vendor then prompts the buyer to submit notification information that will allow the vendor to notify the buyer of the occurrence of triggering event. In this regard, the buyer may submit a telephone number, pager number, email address, fax number or any other information that represents a communication pathway that enables the vendor to contact the purchaser. In another embodiment of the present invention, the buyer may select an option that allows the seller to use presence information to contact the buyer. This option will be discussed more fully below.

It should be appreciated that the buyer may submit the notification information while invoking the notification option. In other words, rather than invoking the option and sending the electronic request to the vendor and then having the vendor send another page to the buyer to submit notification information, the vendor may architect the server system to receive the notification information and the electronic request simultaneously. In this manner, the electronic request to purchase goods or services as well as the notification information are received at step 240.

In one embodiment of the present invention, the server system allows the purchaser to submit information that represents multiple communication pathways and also allows the buyer to designate each pathway with a preference rank. For example, the purchaser may submit a telephone number as a first preference and an email address as a second preference. In this situation, should an event occur that affects the request, the vendor will first email the shopper using the email address, then telephone the shopper using the telephone number.

In another embodiment of the present invention, at step 250, a shopper profile associated with the shopper is created. In this manner, after receiving an electronic request and notification information from a shopper, a shopper profile associated with the shopper is created. The shopper profile stores the electronic request and the notification information received from the shopper is stored therein. The shopper profile will be described more fully below.

At step 260, a system in accordance with the present invention recognizes the occurrence of a triggering event. In one embodiment of the present invention, the system recognizes a triggering event by receiving information and comparing that information to the information stored in the system. For example, the system may receive information that a particular item is out of stock and more of such items will not be received for one week. Subsequently, the system determines which shopper's have purchased the item and notifies them of the triggering event in accordance with the present invention.

Once a triggering event is recognized, at step 270, the notification information associated with the shopper is retrieved. In one embodiment of the present invention, the shopper profile is accessed to retrieve the notification information. In this manner, the shopper profile is found and the notification information therein is retrieved.

In another embodiment of the present invention, the server system utilizes presence information to retrieve notification information to notify the shopper of the occurrence of a triggering event. Presence technology refers to the ability to access real time information about a person's current status by way of their communication devices as well as their communication capabilities and their preferences. Presence technology, also referred to as presence awareness or presence, typically includes a server alert messaging application. Presence creates proactive alerts arising from triggering events and sends the alerts to predefined recipients' email addresses, fax numbers, voice mail, internet/intranet websites, etc. when certain conditions are met. Presence applications make it possible to locate and identify a computing device (including handheld as well as desktop model) whenever the user is connected to a network. Presence can be used in nearly all means of communication including landline telephones, mobile phones, email, VoIP phones and pagers.

The purchaser is then notified, at step 280, that the triggering event has occurred via the communication pathway as represented in the notification information. The actual composition of the notification to the buyer may vary without departing from the scope of the present invention. For example, the vendor may inform the buyer of the occurrence of the triggering event and specify an anticipated delivery date.

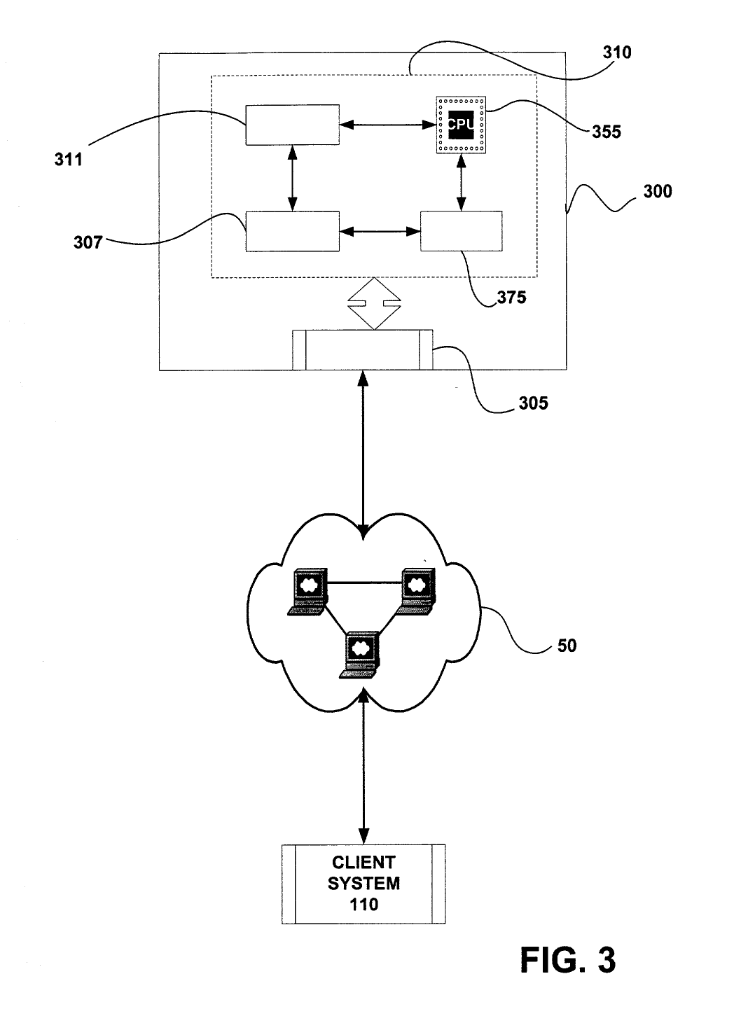

FIG. 3 is a block diagram of a communications network having a server computer system in accordance with the present invention. As shown, client computer system 110 is in communication with communication network 50, such as a computer network. Furthermore, computer network 50 is in communication with server computer system 300. Server computer system 300 includes a network interface 305 for communicating with computer network 50. The specification and design of the network interface 305 is well known to those skilled in the art.

The server system also includes a processor engine 310. Processor engine 310 is in communication with the network interface and includes functionality that performs the method of processing an electronic request to purchase goods or services as described above. In particular, the processor engine includes an event receiver 307, a message routing agent 375, a data storage facility 311 and microprocessor 355.

The event receiver 307 receives updated information concerning the status of a purchase. In this manner, the event receiver 307 receives information relating to categories, such as inventory, production, delivery schedules or the like to the electronic requests to determine if the information will affect the performance of an electronic request. For example, if the event receiver receives information that a particular item is not in inventory, the receiver may search all shopper profiles (which may be located in the data storage facility 311) to determine which shoppers will be affected by the inventory shortage. If it is determined that information has been received that affects a shopper profile, the event receiver 307 will access all affected shopper profiles and retrieve the appropriate information to notify each shopper of the triggering event.

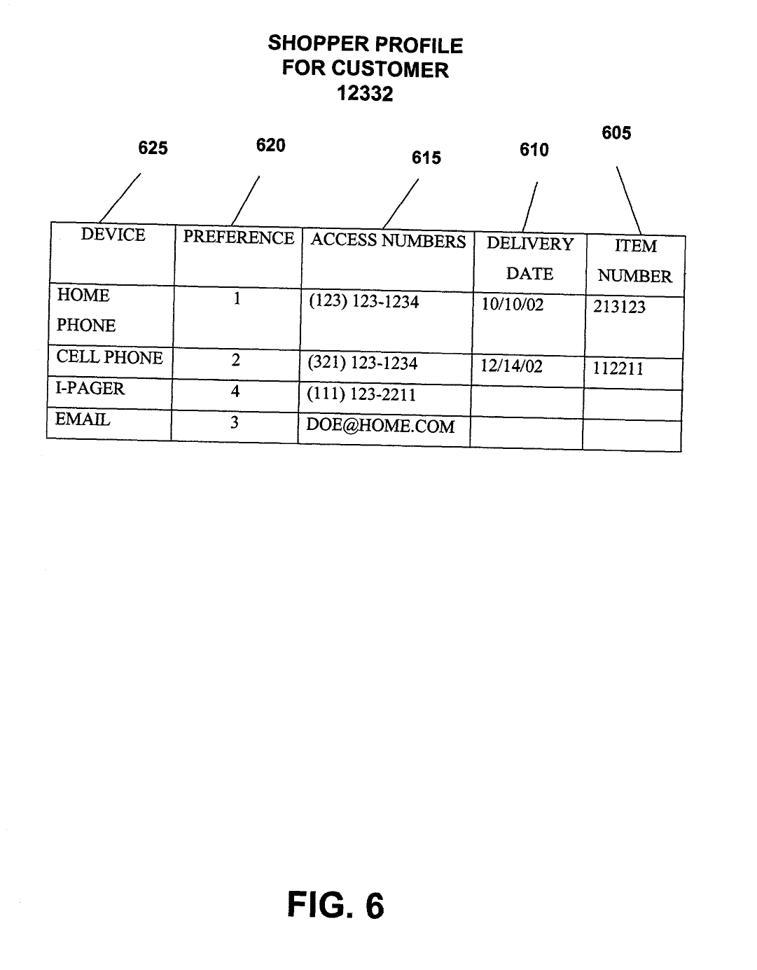

The server system can also include a data storage facility 311. The data storage facility 311 may be located locally, i.e. within the same system that performs the steps as described above, or externally, i.e. within a separate system in communication with the server system as described above. The data storage facility 311 contains shopper profiles containing the electronic request to purchase goods or services and the notification information associated with the shopper. FIG. 6 illustrates the structure of a shopper profile as it might be stored in data storage facility 311. As shown, the shopper profile is for customer 12332 and contains searchable information categorized by device 625, preference rank 620, access numbers 615, delivery dates 610, and item numbers 605.

Referring back to FIG. 3, processor engine 310 can also include a message routing agent 375. After retrieving the notification information from the affected shopper profile, the event receiver 307 sends the notification information to the message routing agent 375. The message routing agent 375 in turn sends the appropriate information concerning the triggering event to the shopper using the appropriate communication method as defined in the notification information. In one embodiment of the present invention, the routing agent 375 sends the information to the shopper using various communications agents (not shown). In this regard, the system includes a voice call agent (not shown) that sends the information to the shopper if the notification information is a telephone number, an Instant Messenger agent (not shown) that sends an instant message to the shopper if the notification information is instant messaging information, an email agent (not shown) that sends an email message to the shopper if the notification information is an email message or the like. The particular agent in turn routes the information to the shopper.

The server system also includes a microprocessor 355. Microprocessor 355 executes any computer instructions for performing the steps according to the present invention.

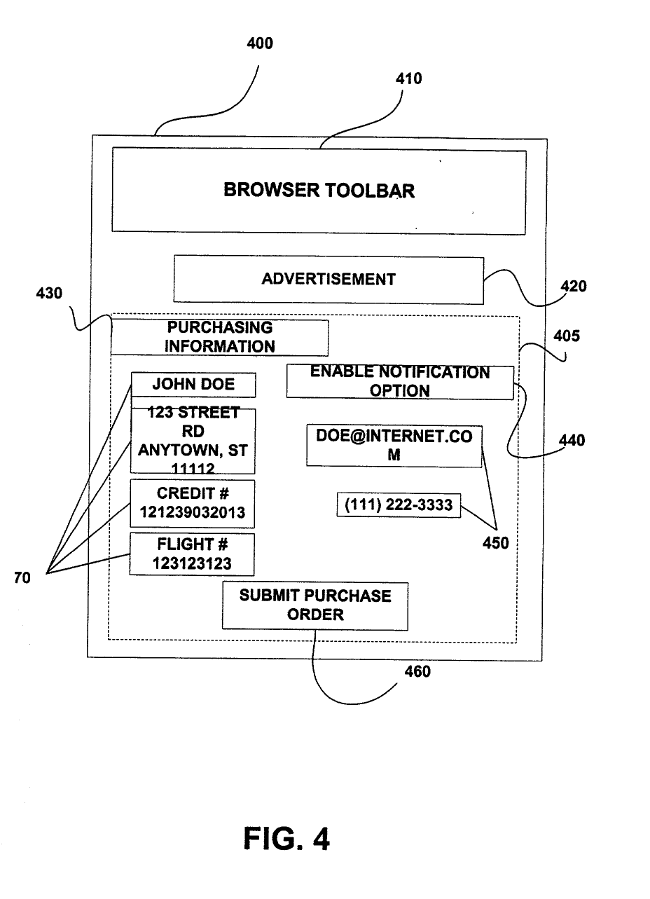

FIG. 4 is an illustration of a computer screen showing a web page incorporating a notification option in accordance with the present invention. FIG. 4 illustrates a web page 400 emulating a purchase order 405 as a shopper would view the same. An internet browser toolbar 410 and an advertisement 420 are located above the purchase order 405.

For example, John Doe, a shopper, may use the WWW to purchase an airline ticket. In this manner, after selecting a flight at a website associated with an airline, an electronic purchase order 405 is sent to John Doe. The purchase order includes a heading labeled purchasing information 430 and text fields 470 associated with purchasing information. John Doe completes the purchase order by filling in the text fields with information such as the shopper's name, address, credit card information, the flight number of the ticket being purchased and the like. After completing the purchase order, John Doe may submit the purchasing information to the vendor by clicking on the submit purchase order button 460.

The purchase order 405, in accordance with the present invention, also includes a notification option button 440 and associated notification text fields 450. In one embodiment of the present invention, the notification option button 440 can be enabled by clicking the button 440. Once enabled, John Doe may then complete the notification text fields 450 by filling in notification information as described above. In the example, as shown, John Doe entered an email address and a pager number as notification information. Then, when John Doe has completed the purchase order, including any notification information, he can submit the information by clicking the submit purchase order button 460. Consequently, should a triggering event such a flight delay occur, John Doe will be so notified by email and then by pager.

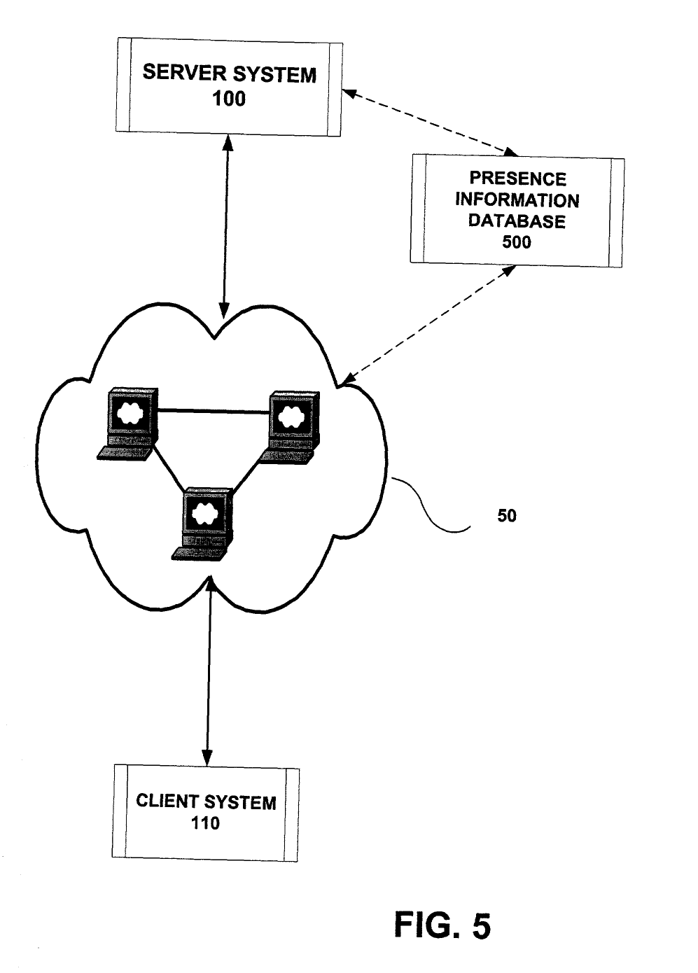

FIG. 5 is a block diagram illustrating a communications network 50 having a server system 100, a client system 110 and a presence information database 500 in communication thereto. As shown, the server system according to the present invention may be directly connected to presence information database 500 or may be connected to the database 500 through the communications network 50.

In this regard, the server system is in communication with a system maintaining presence information concerning the shoppers. Once a triggering event occurs, the server system requests and receives presence information regarding the status of a particular device that shopper is currently using, and uses the presence information to contact the buyer.

As should now be understood, in the present invention, methods and systems are disclosed for processing an electronic request to purchase goods or services Changes could be made to the embodiments disclosed above without departing from the broad inventive concepts thereof. For example, the present invention has been described as being implemented in the WWW, however, other networks may be used to implement the invention, such as, for example, a proprietary intranet or the like. It is understood, therefore, that this invention is not limited to the particular embodiments disclosed, but it is intended to cover modifications within the scope of the present invention as defined by the appended claims.

What is claimed is:

1. A method for processing an electronic request to purchase goods or services, the method comprising:
receiving electronic purchasing information from a shopper via a communications network, the purchasing information containing an electronic request to purchase goods or services and notification information, the notification information representative of at least one communication pathway for communicating with the shopper;
recognizing the occurrence of a triggering event that affects the performance of the electronic request; and
notifying the shopper that the triggering event has occurred via the at least one communication pathway.

2. The method of claim 1 further comprising:
creating a shopper profile associated with the shopper, the shopper profile containing the electronic request and the notification information associated with the shopper; and
accessing the notification information in the shopper profile.

3. The method of claim 1, wherein receiving notification information comprises receiving at least one of an email address, a telephone number and a pager number.

4. The method of claim 1, wherein receiving notification information comprises receiving presence information.

5. The method of claim 1, wherein the notification information is representative of a plurality of communication pathways, each pathway having a preferred rank.

6. The method of claim 1, wherein the communications network is the Internet.

7. A computer having instructions thereon for processing an electronic request to purchase goods or services, the instructions performing the steps comprising:
receiving electronic purchasing information from a shopper via a communications network, the purchasing information containing an electronic request to purchase goods or services and notification information, the notification information representative of at least one communication pathway for communicating with the shopper;
recognizing the occurrence of a triggering event that affects the performance of the electronic request; and
notifying the shopper that the triggering event has occurred via the at least one communication pathway.

8. The computer of claim 7 further comprising:
creating a shopper profile associated with the shopper, the shopper profile containing the electronic request and the notification information associated with the shopper; and
accessing the notification information in the shopper profile.

9. The computer of claim 7, wherein receiving notification information comprises receiving at least one of an email address, a telephone number and a pager number.

10. The computer of claim 7, wherein receiving notification information comprises receiving presence information.

11. The computer of claim 7, wherein the notification information is representative of a plurality of communication pathways, each pathway having a preferred rank.

12. A server computer for processing an electronic request to purchase goods or services from a shopper, the server comprising:
a communications interface connected to a communications network for establishing a communications link between the server and a host client computer;
a processing engine in communication with the communications interface for receiving purchasing information from the shopper via the host client computer and the communications network, the purchasing information containing an electronic request to purchase goods or services; and notification information representative of at least one communication pathway for communicating with the shopper and for recognizing the occurrence of a triggering event that affects the performance of the electronic request.

13. The server system of claim 12 further comprising:
a data storage facility in communication with the processing engine that contains data representing the notification information.

14. The server system of claim 13 wherein the data storage facility further contains:
a shopper profile associated with the shopper and containing the electronic request and the notification information associated with the shopper.

15. The server system of claim 12 further comprising:
a message routing agent adapted to receive notification information.
